(19) United States
(12) Patent Application Publication
(10) Pub. No.: US 2020/0070904 A1
(43) Pub. Date: Mar. 5, 2020

(54) INTERIOR FINISHING MEMBER FOR DRIVER'S CAB IN WORK VEHICLE, COVER FOR OPERATION LEVER IN WORK VEHICLE, AND WORK VEHICLE

(71) Applicant: Kubota Corporation, Osaka-shi (JP)

(72) Inventor: Daisuke YASUNOBE, Sakai-city (JP)

(73) Assignee: Kubota Corporation, Osaka-shi (JP)

(21) Appl. No.: 16/559,647

(22) Filed: Sep. 4, 2019

(30) Foreign Application Priority Data
Sep. 5, 2018 (JP) 2018-166171

(51) Int. Cl. B62D 49/06; B60N 3/04; B60K 26/02

(52) U.S. Cl. CPC B62D 49/0692; B60K 26/02; B60N 3/048

(57) ABSTRACT

An interior finishing member for a driver's cab in a work vehicle includes a bellows. The bellows is configured to be provided at an inner wall to separate an outside and an inside of the driver's cab. The bellows has a hole via which the outside communicates with the inside and through which an operation lever is configured to pass.

### CROSS-REFERENCE TO RELATED APPLICATIONS

The present application claims priority under 35 U.S.C. § 119 to Japanese Patent Application No. 2018-166171, filed Sep. 5, 2018. The contents of this application are incorporated herein by reference in their entirety.

### BACKGROUND OF THE INVENTION

### Field of the Invention

The present application discloses techniques relating to an interior finishing member for a driver's cab in a work vehicle, a cover for an operation lever in the work vehicle, and the work vehicle.

### Discussion of the Background

There has been known a work vehicle including a driver's cab, as an agricultural work vehicle (see Japanese Registered Design No. 1281351, for example). The driver's cab is equipped with an operation lever.

### SUMMARY OF THE INVENTION

According to one aspect of the present invention, an interior finishing member for a driver's cab in a work vehicle includes a bellows. The bellows is configured to be provided at an inner wall to separate an outside and an inside of the driver's cab. The bellows has a hole via which the outside communicates with the inside and through which an operation lever is configured to pass.

According to another aspect of the present invention, a cover for an operation lever of a work vehicle includes an attachment and a bellows. The attachment is configured to be attached to an inner wall to separate an outside and an inside of a driver's cab. The bellows is provided to be surrounded with the attachment. The bellows has a hole through which the outside communicates with the inside and through which an operation lever is configured to pass.

According to further aspect of the present invention, a work vehicle includes an inner wall, an interior finishing member, and an operation lever. The inner wall separates an outside and an inside of a driver's cab and has an opening for communication between the outside and the inside. The interior finishing member is provided along the inner wall and provided with a bellows positioned to face the opening. The bellows has a hole. The operation lever passes through the hole.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side view of a work vehicle according to a first embodiment.

FIG. 2 is a plan view of a driver's cab in the work vehicle.

FIG. 3 is a perspective view depicting disposition of a speed control pedal.

FIG. 4 is a perspective view depicting disposition of a pedal support lever outside the driver's cab.

FIG. 5A is a top view of a mat, and FIG. 5B is a rear view of the mat.

FIG. 6 is a top view of a bellows.

FIG. 7 is a sectional view of the mat taken along line VII-VII indicated in FIG. 6.

FIG. 8 is a sectional view of the mat taken along line VIII-VIII indicated in FIG. 6.

FIG. 9 is an enlarged view of the sectional view depicted in FIG. 7.

FIG. 10A is a perspective view of the pedal support lever having an upper end shifted forward, and FIG. 10B is a perspective view of the pedal support lever having the upper end shifted backward.

FIG. 11 is a perspective view of a mat and a cover of a pedal support lever in a work vehicle according to a second embodiment.

### DETAILED DESCRIPTION OF EMBODIMENTS

The embodiments will now be described with reference to the accompanying drawings, wherein like reference numerals designate corresponding or identical elements throughout the various drawings.

Embodiments will now be described below with reference to the drawings. Same reference signs denote corresponding or identical configurations in the drawings.

### First Embodiment

### <Entire Configuration>

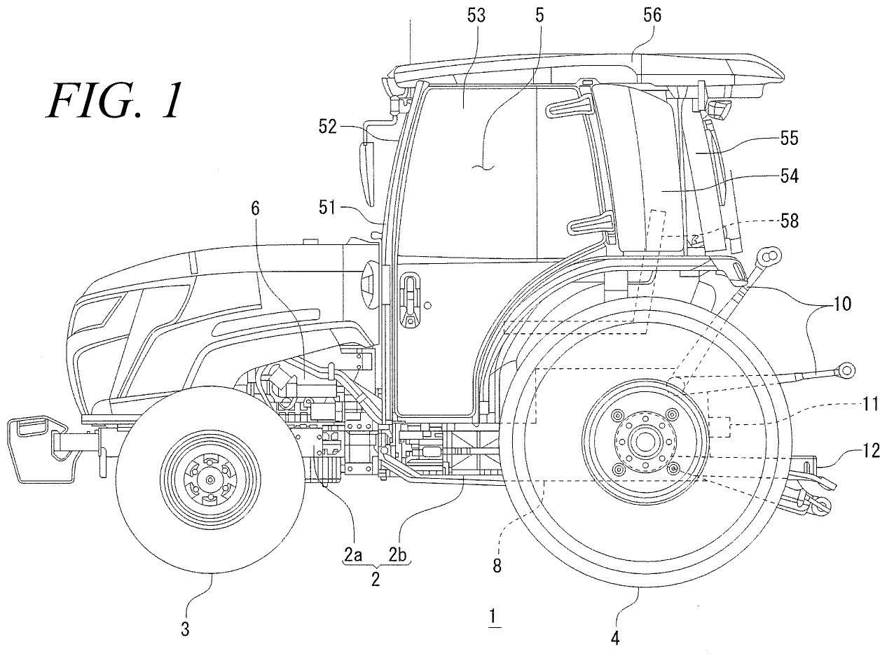

FIG. 1 is a side view of a work vehicle 1 according to the first embodiment.

Examples of the work vehicle 1 include an agricultural tractor. The work vehicle 1 includes a vehicle body frame 2, traveling wheels 3 and 4, and a driver's cab 5. The work vehicle 1 is preferably a four-wheel drive vehicle configured to rotary drive the four traveling wheels 3 and 4 to travel.

The embodiments in the present application refer to an anteroposterior direction indicating an anteroposterior direction viewed from an operator seated on a driver's seat 58 provided in the driver's cab 5. A transverse direction and a lateral direction indicate a transverse direction and a lateral direction viewed from the operator. A vertical direction indicates a vertical direction viewed from the operator. Assume that anteroposterior, transverse (lateral), and height directions of the work vehicle 1 match the anteroposterior, transverse (lateral), and vertical directions viewed from the operator, respectively.

The vehicle body frame 2 includes a front frame 2a and a rear frame 2b. The front frame 2a is provided with an engine 6. The rear frame 2b is provided with the driver's cab 5 and a transmission case 8. The transmission case 8 accommodates a travel gearbox configured to transmit drive power from the engine 6 to the traveling wheels 3 and 4, and the like. The transmission case 8 further accommodates a work device gearbox configured to distribute motive power from the engine 6 to a work device (not depicted) separately from the traveling wheels 3 and 4, a clutch, and the like. The work device gearbox, the clutch, and the like constitute a motive power transmission system to be called a work transmission system.

The work vehicle 1 further includes a pair of lift arms 10, a power take-off shaft (PTO shaft) 11, and a traction device 12. The lift arms 10 are provided respectively on right and left sides of the work vehicle 1 one by one. The lift arms 10 are each configured to swing upward and downward along with operation of a hydraulic lift cylinder included in the work transmission system. The PTO shaft 11 functions as an output shaft for motive power of the work transmission system. The pair of lift aims 10 are coupled to a link mechanism (not depicted), and the PTO shaft 11 is connected to a transmission shaft for transmission of motive power to a work device (not depicted) like a rotary tillage device coupled to the link mechanism. The traction device 12 includes a convey carrier (not depicted) coupled to a rear end of the work vehicle 1 for conveyance.

### <Internal Configuration of Driver's Cab>

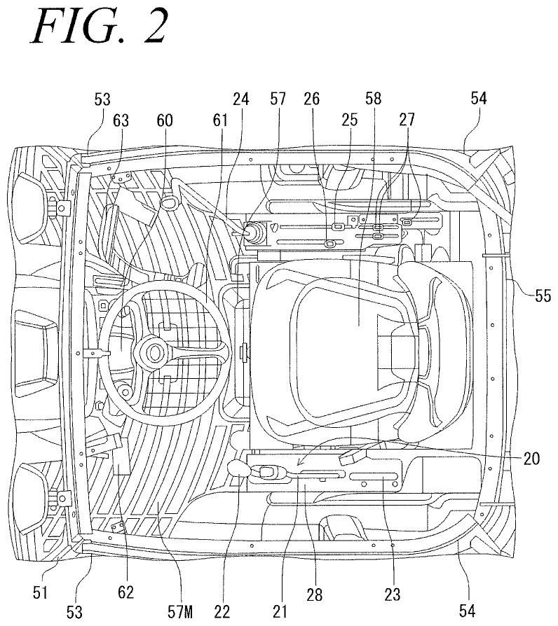

The driver's cab 5 is a space surrounded with a cabin frame 51, a windshield 52, door panels 53, side windows 54, a rear window 55, and a roof 56. The cabin frame 51 supports the windshield 52, the door panels 53, the side windows 54, the rear window 55, and the roof 56. The roof 56 has an internal storage space for an air conditioner, a wireless communication device, and the like. FIG. 2 is a plan view of an interior of the driver's cab 5 excluding the roof 56. The driver's cab 5 in the work vehicle 1 includes a floor panel 57, a mat 57M, and the driver's seat 58. The floor panel 57 constitutes a bottom wall (exemplifying an inner wall) of the driver's cab 5 to separate an outside and an inside of the driver's cab 5. The mat 57M exemplifies an interior finishing member of the driver's cab 5 and is laid along the floor panel 57. The floor panel 57 is provided therebehind with the driver's seat 58. The windshield 52 is transparent and constitutes a front end of the driver's cab 5. The door panels 53 are transparent and are provided at right and left ends of the driver's cab 5. The door panels 53 are outwardly openable. Being outwardly openable indicates being openable to be distant from the floor panel 57 and the driver's seat 58. The side windows 54 are transparent and are provided at right and left ends of the driver's cab 5 and behind the door panels 53. The side windows 54 are also outwardly openable. The rear window 55 is transparent and constitutes a rear end of the driver's cab 5. The rear window 55 is also outwardly openable.

The work vehicle 1 includes an operation mechanism 20 disposed on the left of the driver's seat 58 in the driver's cab 5. The operation mechanism 20 includes a first operation lever 21, a second operation lever 22, and a third operation lever 23. The operation mechanism 20 may not necessarily include the third operation lever 23. The third operation lever 23 may alternatively be disposed at a location other than the left side of the driver's seat 58. The first operation lever 21 is configured as a gear shift lever. The first operation lever 21 preferably has three gear levels of LOW, MIDDLE, and HIGH, which are selected for low-speed travel, middle-speed travel, and high-speed travel, respectively. The first operation lever 21 is slidable in an anteroposterior direction. The first operation lever 21 may be slid forward to set the gear level to LOW. The first operation lever 21 may be slid to the middle to set the gear level to MIDDLE. The first operation lever 21 may be slid backward to set the gear level to HIGH. The first operation lever 21 may alternatively be configured to set the gear level to HIGH when slid forward and set the gear level to LOW when slid backward. The second operation lever 22 is preferably configured to set whether or not to drive front wheels (the traveling wheels 3). The second operation lever 22 is disposed ahead of the first operation lever 21. The second operation lever 22 is swingable in an anteroposterior direction. When the second operation lever 22 is tilted forward, the front wheels 3 may be driven to achieve four-wheel drive travel of the work vehicle 1 (“4WD ON”). When the second operation lever 22 is tilted backward, only rear wheels 4 may be driven to achieve two-wheel drive travel of the work vehicle 1 (“4WD OFF”). The second operation lever 22 may alternatively be configured to turn OFF four-wheel drive when being tilted forward and turn ON four-wheel drive when being tilted backward. The third operation lever 23 is slidable in an anteroposterior direction. When the third operation lever 23 is slid forward, the work vehicle 1 continues forward travel without operation of a speed control pedal 63 to be described later. When the third operation lever 23 is slid backward, the work vehicle 1 discontinues forward travel. The first to third operation levers 21 to 23 are mechanically connected to the travel gearbox and the like accommodated in the transmission case 8. Each of the first to third operation levers 21 to 23 may alternatively be electrically connected, via a switch or the like, to the travel gearbox and the like accommodated in the transmission case 8.

The work vehicle 1 includes a fourth operation lever 24, a fifth operation lever 25, a sixth operation lever 26, and seventh operation levers 27, which are disposed on the right of the driver's seat 58 in the driver's cab 5. The fourth operation lever 24 is relevant to the work transmission system (output from the PTO shaft 11). The fifth operation lever 25 is configured to vertically shift the work device (not depicted). The fifth operation lever 25 is swingable in an anteroposterior direction. When the fifth operation lever 25 is tilted backward, the lift arms 10 may shift the work device upward. When the fifth operation lever 25 is tilted forward, the lift aims 10 may shift the work device downward. Alternatively, the fifth operation lever 25 tilted backward may cause the lift arms 10 to shift the work device downward, and the fifth operation lever 25 tilted forward may cause the lift arms 10 to shift the work device upward. The sixth operation lever 26 is configured to set for control of the lift arms 10 to shift the work device vertically in accordance with unevenness or hardness of soil (cause the work device to follow change of soil) for achievement of constant tractive force of the work device as much as possible, or to set for control of the lift arms 10 not to cause the work device to follow such change of soil. The sixth operation lever 26 is swingable in an anteroposterior direction. When the sixth operation lever 26 is tilted backward, the work vehicle 1 may control the lift arms 10 to cause the work device to follow change of soil. When the sixth operation lever 26 is tilted forward, the work vehicle 1 may controls the lift arms 10 not to cause the work device to follow change of soil. The work vehicle 1 is also configured to control the lift arms 10 to float the work device above soil. When the sixth operation lever is further tilted forward from a position for not causing the work device to follow change of soil, the work vehicle 1 may control the lift arms 10 to float the work device above soil. The seventh operation levers 27 include levers configured to directly control the lift cylinders of the lift arms 10.

As depicted in FIG. 2, the work vehicle 1 includes a display 60, a steering wheel 61, a brake pedal 62, the speed control pedal 63, and the like, which are disposed in the driver's cab 5.

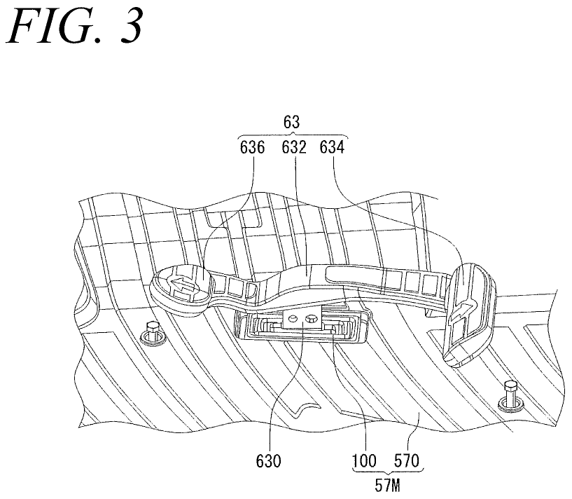

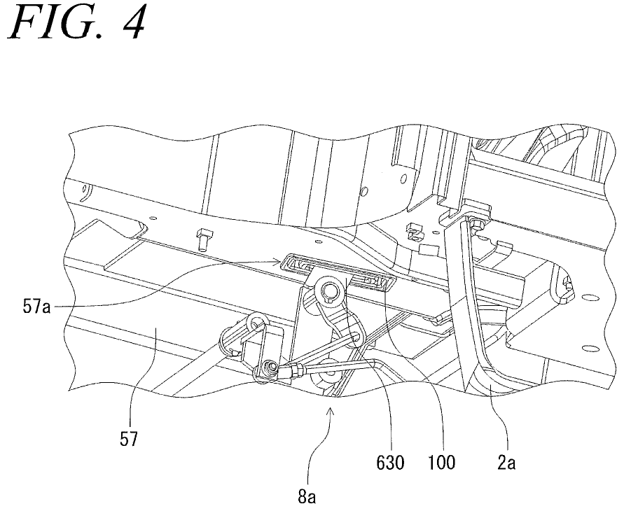

FIG. 3 is a perspective view depicting disposition of the speed control pedal 63. FIG. 4 is a view depicting disposition of a pedal support lever 630 outside the driver's cab. As depicted in FIG. 3, the speed control pedal 63 is supported by the pedal support lever 630 (exemplifying an operation lever) in the driver's cab 5. Specifically, the speed control pedal 63 has a forward travel press part 634, a backward travel press part 636, and a coupling part 632. The coupling part 632 extends in a first direction to couple the forward travel press part 634 and the backward travel press part 636. The first direction is along the anteroposterior direction of the work vehicle 1. The coupling part 632 is disposed between the forward travel press part 634 and the backward travel press part 636 in the first direction and is attached to the pedal support lever 630.

The first direction being along the anteroposterior direction of the work vehicle 1 means that the first direction and the anteroposterior direction of the work vehicle 1 form an angle smaller than an angle formed between the first direction and the transverse direction of the work vehicle 1.

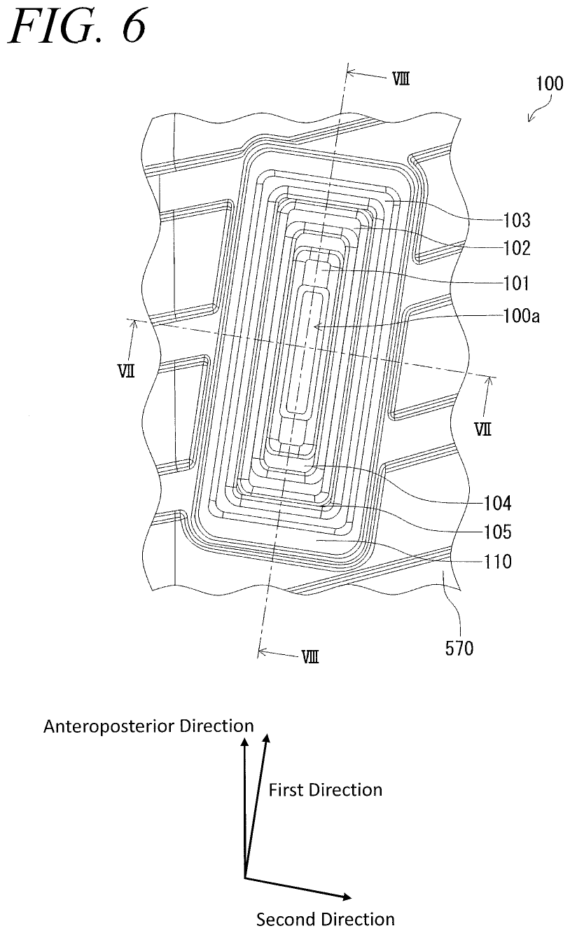

As depicted in FIG. 4, outside the driver's cab 5, the pedal support lever 630 is coupled to a transmission link mechanism 8a. As depicted in FIGS. 3 and 4, the pedal support lever 630 extends from inside to outside the driver's cab 5. More specifically, the floor panel 57 has an opening 57a. There is provided a bellows 100 attached to the mat 57M to be positioned at the opening 57a. The bellows 100 has a hole 100a (see FIG. 6) allowing communication between the outside and the inside of the driver's cab 5. The pedal support lever 630 passes through the opening 57a and the hole 100a in the height direction of the work vehicle 1.

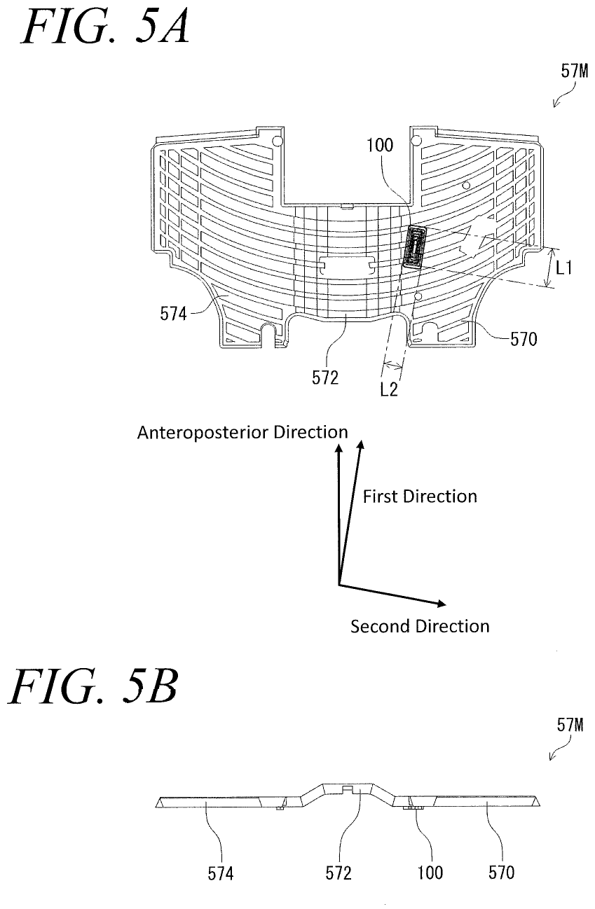

FIG. 5A is a top view of the mat 57M. FIG. 5B is a rear view of the mat 57M. The mat 57M is shaped to have a small thickness. Specifically, the mat 57M is has a smaller length in the height direction of the work vehicle 1 than a length of the mat 57M in the anteroposterior direction of the work vehicle 1 and a length of the mat 57M in the transverse direction of the work vehicle 1. The mat 57M has a right sheet 570, a left sheet 574, and a middle sheet 572. The right sheet 570, the middle sheet 572, and the left sheet 574 are laid in a right portion, a middle portion, and a left portion of the floor panel 57 in the transverse direction of the work vehicle 1, respectively. As depicted in FIG. 5B, the middle sheet 572 is curved upward in the height direction of the work vehicle 1. The right sheet 570 and the left sheet 574 according to the present embodiment each have a substantially flat shape, which is not necessarily restricted in the present invention.

The bellows 100 is disposed at the right sheet 570 to be adjacent to the middle sheet 572 in the transverse direction of the work vehicle 1. The bellows 100 is disposed to be distant from a front end and a rear end of the right sheet 570 in the anteroposterior direction of the work vehicle 1. In comparison to a case where the bellows 100 is disposed at the middle sheet 572 being curved upward, provision of the bellows 100 at the right sheet 570 facilitates production of the mat 57M having the bellows 100. The bellows 100 is disposed to be distant from the front end of the rear end of the right sheet 570. This disposition inhibits the right sheet 570 from shifting with respect to the floor panel 57 even when the bellows 100 expands or contracts in the anteroposterior direction of the work vehicle 1.

As depicted in FIG. 5A, the bellows 100 has a substantially rectangular shape when viewed in the height direction of the work vehicle 1. More specifically, the bellows 100 has a length L1 in the first direction larger than a length L2 in a second direction perpendicular to the first direction. The bellows 100 thus easily expands and contracts in the first direction. In other words, the bellows 100 easily expands and contracts in the anteroposterior direction of the work vehicle 1. As depicted in FIG. 5B, the bellows 100 is positioned below the right sheet 570 in the height direction of the work vehicle 1. Each of the bellows 100 and the right sheet 570 may alternatively be disposed at an upper end position or a lower end position in the height direction of the work vehicle 1. In this manner, the bellows 100 does not project upward from the right sheet 570 in the height direction of the work vehicle 1. The bellows 100 is thus less likely to impede walking of the operator.

The bellows 100 viewed in the height direction of the work vehicle 1 may alternatively have a substantially elliptical shape having a major axis extending along the first direction and a minor axis extending along the second axis. The bellows 100 viewed in the height direction of the work vehicle 1 is not limited to the substantially rectangular shape or the substantially elliptical shape.

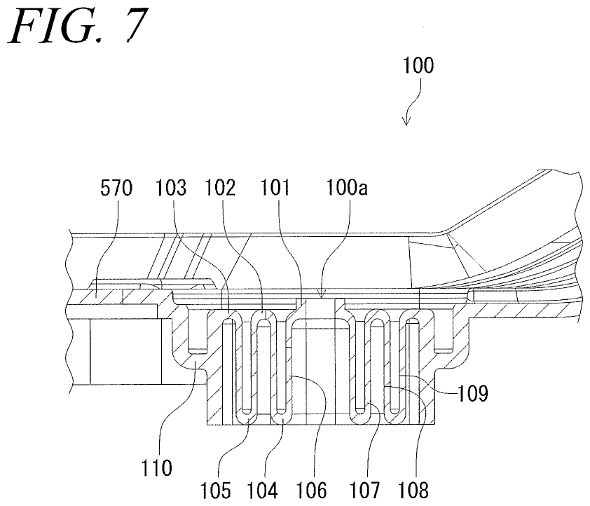

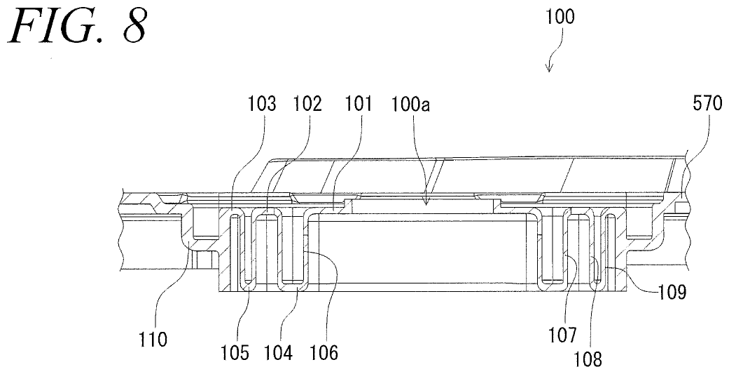

FIG. 6 is a top view of the bellows 100. FIG. 7 is a sectional view of the bellows 100 taken along line VII-VII indicated in FIG. 6. FIG. 8 is a sectional view of the bellows 100 taken along line VIII-VIII indicated in FIG. 6. The bellows 100 has a plurality of concave portions and a plurality of convex portions alternately disposed to be adjacent to each other along the extending floor panel 57 to surround a hole 100a provided at a center portion 101. The hole 100a has a substantially rectangular shape when viewed in the height direction of the work vehicle 1. More specifically, the hole 100a has a larger length in the first direction than a length in the second direction. The hole 100a has only to correspond to a sectional shape of the pedal support lever 630 and is not limited to the shape depicted in FIG. 6.

The bellows 100 has a bellows structure constituted by the plurality of convex portions and the plurality of concave portions alternately disposed to be adjacent to each other. More specifically, the bellows 100 has a concave portion 104 disposed most adjacent to the center portion 101, a convex portion 102, a concave portion 105, and a convex portion 103 aligned in the mentioned order. As depicted in FIG. 6, each of the concave portion 104, the convex portion 102, the concave portion 105, and the convex portion 103 has an outer periphery and an inner periphery each having a rectangular shape when viewed in the height direction of the work vehicle 1. FIGS. 7 and 8 depict a wall 106 connecting the center portion 101 and the concave portion 104. The concave portion 104 and the convex portion 102 are connected via a wall 107. The convex portion 102 and the concave portion 105 are connected via a wall 108. The concave portion 105 and the convex portion 103 are connected via a wall 109. The walls 106 to 109 extend substantially in parallel with the height direction of the work vehicle 1. The convex portion 103 is connected to the right sheet 570 via a connecting part 110. The connecting part 110 is provided to inhibit excessive expansion and contraction of the bellows 100. Specifically, the connecting part 110 is thicker than the walls 106 to 109. The connecting part 110 is not necessarily provided.

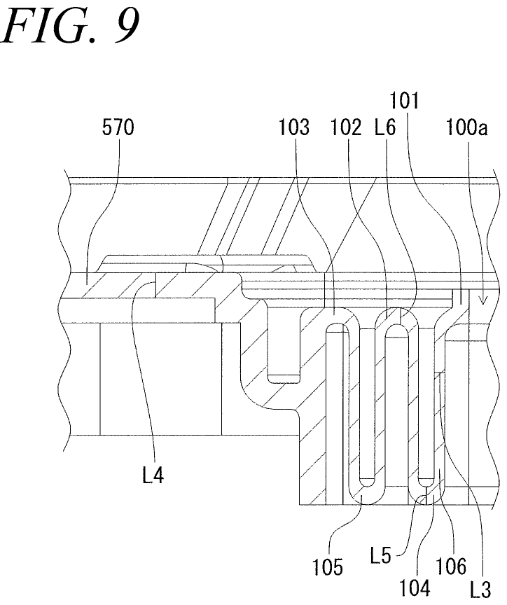

As depicted in an enlarged view of FIG. 9, the wall 106 has a thickness L3 smaller than a thickness L4 of the right sheet 570. The concave portion 104 has a thickness L5 and the convex portion 102 has a thickness L6, and the thickness L5 and the thickness L6 are smaller than the thickness L4 of the right sheet 570. The thickness L3 of the wall 106 corresponds to a length of the wall 106 in the second direction. The length L3 is substantially equal to a length of the wall 106 in the first direction. The thickness L4 of the right sheet 570, the thickness L5 of the concave portion 104, and the thickness L6 of the convex portion 102 correspond to a length of the right sheet 570, a length of the concave portion 104, and a length of the convex portion 102, respectively, in the height direction of the work vehicle 1. Each of the walls 107 to 109 is substantially equal in thickness to the wall 106. The concave portion 105 has a thickness substantially equal to the thickness L5 of the concave portion 104. The convex portion 103 has a thickness substantially equal to the thickness L6 of the convex portion 102. When the convex portion 102, the convex portion 103, the concave portion 104, the concave portion 105, and the walls 106 to 109 each have the thickness smaller than the thickness L4 of the right sheet 570, the bellows 100 easily expands and contracts.

The mat 57M according to the present embodiment has the right sheet 570 and the bellows 100 surrounded with the right sheet 570. In other words, the right sheet 570 and the bellows 100 are provided integrally with each other. The right sheet 570 and the bellows 100 form no gap therebetween to inhibit entry of dust and the like from outside to inside the driver's cab 5.

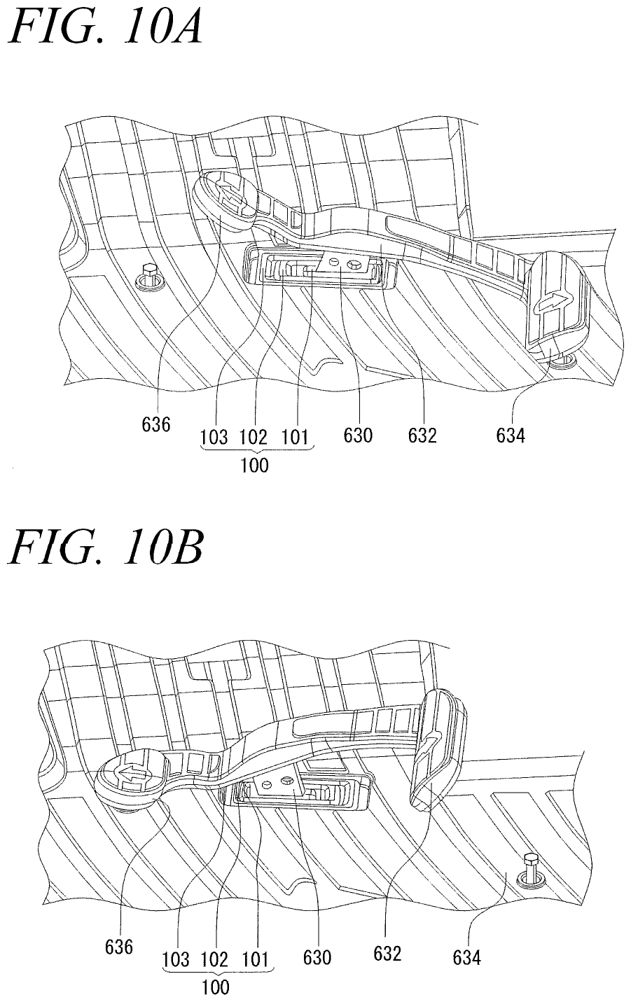

FIG. 10A is a perspective view of the pedal support lever 630 having an upper end shifted forward. FIG. 10B is a perspective view of the pedal support lever 630 having the upper end shifted backward.

As depicted in FIG. 10A, when the forward travel press part 634 is pushed down by the operator, the pedal support lever 630 presses the concave portion 104, the convex portion 102, the concave portion 105, and the convex portion 103 disposed in a front portion of the work vehicle 1 in the first direction, and pulls the concave portion 104, the convex portion 102, the concave portion 105, and the convex portion 103 disposed in a rear portion of the work vehicle 1 in the first direction. Accordingly, the concave portion 104, the convex portion 102, the concave portion 105, and the convex portion 103 in the front portion of the work vehicle 1 in the first direction have narrowed gaps, and the concave portion 104, the convex portion 102, the concave portion 105, and the convex portion 103 in the rear portion of the work vehicle 1 in the first direction have widened gaps. This enlarges the hole 100a to inhibit communication between the outside and the inside of the driver's cab 5.

As depicted in FIG. 10B, when the backward travel press part is pushed down by the operator, the pedal support lever 630 presses the concave portion 104, the convex portion 102, the concave portion 105, and the convex portion 103 disposed in the rear portion of the work vehicle 1 in the first direction, and pulls the concave portion 104, the convex portion 102, the concave portion 105, and the convex portion 103 disposed in the front portion of the work vehicle 1 in the first direction. Accordingly, the concave portion 104, the convex portion 102, the concave portion 105, and the convex portion 103 in the rear portion of the work vehicle 1 in the first direction have narrowed gaps, and the concave portion 104, the convex portion 102, the concave portion 105, and the convex portion 103 in the front portion of the work vehicle 1 in the first direction have widened gaps. This enlarges the hole 100a to inhibit communication between the outside and the inside of the driver's cab 5.

As described above, even when the speed control pedal 63 is manipulated by the operator and the upper end of the pedal support lever 630 shifts in the first direction, the hole 100a expands in the first direction to inhibit communication between the outside and the inside of the driver's cab 5. This inhibits entry of dust and the like from outside to inside the driver's cab 5 through the hole 100a.

### Second Embodiment

The work vehicle 1 according to the first embodiment includes the right sheet 570 and the bellows 100 provided integrally with each other. The second embodiment provides a work vehicle 1A different from the work vehicle 1 according to the first embodiment in that the bellows 100 and a right sheet 570A are provided separately from each other. Identical configurations in the first and second embodiments will not be described repeatedly.

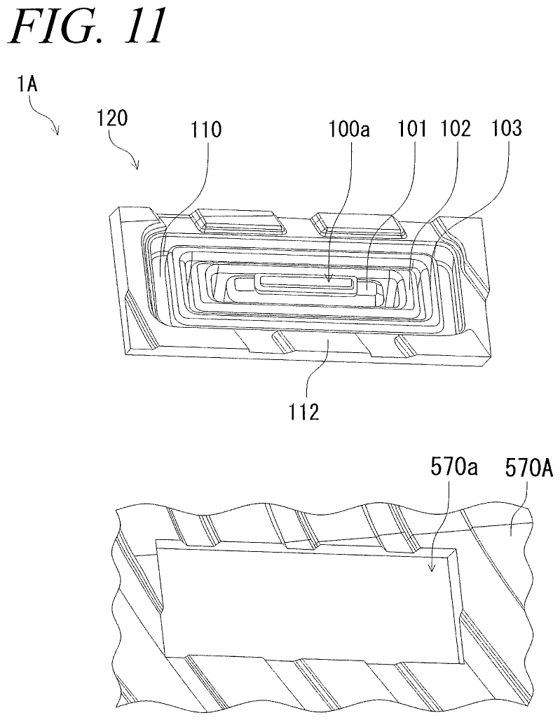

FIG. 11 depicts a cover 120 including the bellows 100 and an attachment 112. The attachment 112 extends outward from the convex portion 103 in a direction substantially perpendicular to the extending hole 100a in the bellows 100. Specifically, the bellows 100 is surrounded with the attachment 112. The right sheet 570A is different from the right sheet 570 according to the first embodiment in that the right sheet 570A has an opening 570a. The opening 570a is provided to face the opening 57a in the floor panel 57. The attachment 112 is attached to the right sheet 570A to close the opening 570a in the right sheet 570A. In other words, the attachment 112 is attached to the floor panel 57 via the right sheet 570A of the mat 57M.

The attachment 112 and the bellows 100 are provided integrally with each other in the present embodiment. The attachment 112 and the bellows 100 may alternatively be provided separately from each other. The present embodiment provides the connecting part 110 between the attachment 112 and the convex portion 103. The connecting part 110 may not necessarily be provided.

### Other Embodiments

The bellows 100 may be provided correspondingly to the position of the pedal support lever 630. The bellows 100 may alternatively be provided at the left sheet 574 or at the middle sheet 572. The bellows 100 may still alternatively be provided across a boundary between the right sheet 570 and the middle sheet 572.

The mat 57M may be laid along a side wall as well as the bottom wall of the driver's cab 5. The bellows 100 may be provided correspondingly to the side wall of the driver's cab 5 in this case. Specifically, the bellows 100 may be provided along the side wall such that an operation levers penetrating the side wall of the driver's cab 5 passes through the hole 100a.

The mat 57M may not necessarily be provided. Specifically, the bellows 100 may be attached to the inner wall of the driver's cab 5 to close an opening provided in the inner wall.

The bellows 100 may expand and contract in a direction according to motion of the operation lever. The direction is not limited to that exemplified above.

The bellows structure of the bellows 100 is not limited to that exemplified above. The bellows 100 may have any bellows structure for expansion and contraction as long as the hole 100a does not expand along with motion of the pedal support lever 630.

The pedal support lever 630 is attached to the speed control pedal 63 manipulated with a foot of the operator. The pedal support lever 630 may alternatively be attached to a tool manipulated with any part other than the foot of the operator. The lever may still alternatively be manipulated directly.

The present application refers to words “include” and derivatives as nonrestrictive terms for description of provision of constituent elements, without exclusion of any other constituent element not referred to in the present application. The same applies to words “have”, “provided with”, and derivatives thereof.

Expressions “member”, “part”, “element”, “body”, and “structure” may have a plurality of meanings indicating a single portion and a plurality of portions.

Ordinal numbers “first”, “second”, and the like are terms for simple distinction among configurations, without having any other meaning (e.g. specific order). For example, provision of a “first element” does not indicate provision of a “second element”, and provision of the “second element” does not indicate provision of the “first element”.

Expressions “substantially”, “approximately”, “about”, and the like indicating degrees may each have a rational deviation not significantly changing a final result. All the numerical values referred to in the present application may be interpreted as including any one of the expressions “substantially”, “approximately”, “about”, and the like.

In view of the above disclosure, the present invention can obviously include various modifications and alterations. The present invention may thus be implemented in any manner different from those specifically disclosed in the present application without departing from the spirit of the preset invention.

Obviously, numerous modifications and variations of the present invention are possible in light of the above teachings. It is therefore to be understood that within the scope of the appended claims, the invention may be practiced otherwise than as specifically described herein.

What is claimed is:

1. An interior finishing member for a driver's cab in a work vehicle, comprising:
a bellows configured to be provided at an inner wall to separate an outside and an inside of the driver's cab, the bellows having a hole via which the outside communicates with the inside and through which an operation lever is configured to pass.

2. The interior finishing member according to claim 1, further comprising:
a sheet provided along the inner wall to surround the bellows.

3. The interior finishing member according to claim 2, wherein
the sheet is laid on a bottom wall of the driver's cab, and
the operation lever is attached to a pedal provided in the driver's cab.

4. The interior finishing member according to claim 3, wherein
the bellows is positioned below the sheet in a height direction of the driver's cab.

5. The interior finishing member according to claim 2, wherein
the bellows has at least one convex portion, at least one concave portion, and at least one wall each of which connects one of the at least one convex portion and one of the at least one concave portion, the one of the at least one concave portion being provided adjacent to the one of the at least one convex portion, and
each of the at least one wall is smaller in thickness than the sheet.

6. A cover for an operation lever of a work vehicle, comprising:
an attachment configured to be attached to an inner wall to separate an outside and an inside of a driver's cab; and
a bellows provided to be surrounded with the attachment, the bellows having a hole through which the outside communicates with the inside and through which an operation lever is configured to pass.

7. The cover according to claim 6, wherein
the attachment is configured to be attached to an opening provided in an interior finishing member provided along the inner wall.

8. The cover according to claim 7, wherein
the interior finishing member is laid on a bottom wall of the driver's cab, and
the operation lever is attached to a pedal provided in the driver's cab.

9. The cover according to claim 8, wherein
the bellows is positioned below the interior finishing member in a height direction of the driver's cab.

10. The cover according to claim 7, wherein
the bellows has at least one convex portion, at least one concave portion, and at least one wall each of which connects one of the at least one convex portion and one of the at least one concave portion, the one of the at least one concave portion being provided adjacent to the one of the at least one convex portion, and
each of the at least one wall is smaller in thickness than the interior finishing member.

11. A work vehicle comprising:
an inner wall separating an outside and an inside of a driver's cab and having an opening for communication between the outside and the inside;
an interior finishing member provided along the inner wall and provided with a bellows positioned to face the opening, the bellows having a hole; and
an operation lever passing through the hole.
